(19) United States
(12) Patent Application Publication
(10) Pub. No.: US 2005/0039702 A1
(43) Pub. Date: Feb. 24, 2005

(54) Animal care garment

(76) Inventor: Judith K. Laffoon, Kansas City, MO (US)

Correspondence Address: ERICKSON & KLEYPAS, L.L.C., 800 W. 47TH STREET, SUITE 401, KANSAS CITY, MO, 64112, US

(21) Appl. No.: 10/642,780

(22) Filed: Aug. 18, 2003

(51) Int. Cl. A01K 13/00

(52) U.S. Cl. 119/850

(57) ABSTRACT

An animal care garment for protecting the clothing of the wearer while handling a pet such as a bird, reptile or small mammal. The garment may include a pair of parallel, spaced pads attached to at least one shoulder of the garment to provide a perch for a pet to move about on or rest on during handling. A loop for attaching a leash, toys or other objects to the garment may extend from the channel formed between the pads. The garment may also provide a lip or pocket for collecting waste or food that drops from the animal during handling.

### BACKGROUND OF THE INVENTION

This invention relates to animal care garments used to protect the wearer when handling animals such as birds, reptiles and small mammals. More particularly, the present invention relates to an animal care garment including soft, washable, integral perches provided at the shoulders, means for attaching objects such as a pet leash, toys or food items near the perches, and a receptacle for capturing food, waste or other materials emanating from the perch area.

### SUMMARY OF THE INVENTION

In accordance with the invention, an item of apparel, such as a vest or cape, adapted to provide a comfortable, washable garment for use when handling and caring for pets such as birds, reptiles or small mammals. The garment is preferably constructed of a washable, stain-resistant fabric. A “perch” is provided on the upper surface of a least one shoulder of the garment. The perch comprises an elongated pad, preferably formed from a length of fabric-covered rope, attached to the garment along the shoulder line. In the preferred embodiment, a perch is provided on each shoulder, each perch comprising two pads attached in parallel along the shoulder-line. A channel is thereby created between each pair of ropes. A loop of fabric or other material may be attached to the bottom surface of the channel.

The pads provide a perch particularly suitable for birds such as parrots. Toys, food or a pet leash may be attached to the loop. Large pockets may be provided in the front of the garment for food or grooming equipment, or to carry small animals such as hamsters, baby birds or reptiles. Elastic ribbons may be used to attach the front panel of the garment to the back panel. In the case of an open-front vest, after the vest is placed on the wearer, the front panels may be closed by attachment to one another via Velcro strips.

The entire garment is washable, including the perches. To provide perches that do not readily retain water, synthetic rope material may be used to form the interior of each pad. Pockets are typically gapped so that they remain partially open to catch waste products and feed. In the cape embodiment, the lower edge and sides of the cape may form an extended lip. Both the pockets and lip preferably curve upwards at the outer margins of the garment so that feed or waste that is thrown or excreted in a sideways direction may be captured.

### BRIEF DESCRIPTION OF THE FIGURES

FIG. 1 is a front view of an animal care garment in accordance with the present invention.

FIG. 2. is a back view of the animal care garment illustrated in FIG. 1.

FIG. 2A is a top view of the animal care garment illustrated in FIGS. 1 and 2 with the front and back panels drawn outward to lie in a common plane.

FIG. 3 is an enlarged, partial view of the shoulder apex portion of an animal care garment illustrating pads and attachment loop.

FIG. 4 is a front view of an alternative embodiment of an animal care garment.

FIG. 5 is a side view of the animal care garment of FIG. 4.

FIG. 6 is a back view of the animal care garment of FIG. 5.

FIG. 7 is a front view of an alternative embodiment of an animal care garment.

### DETAILED DESCRIPTION

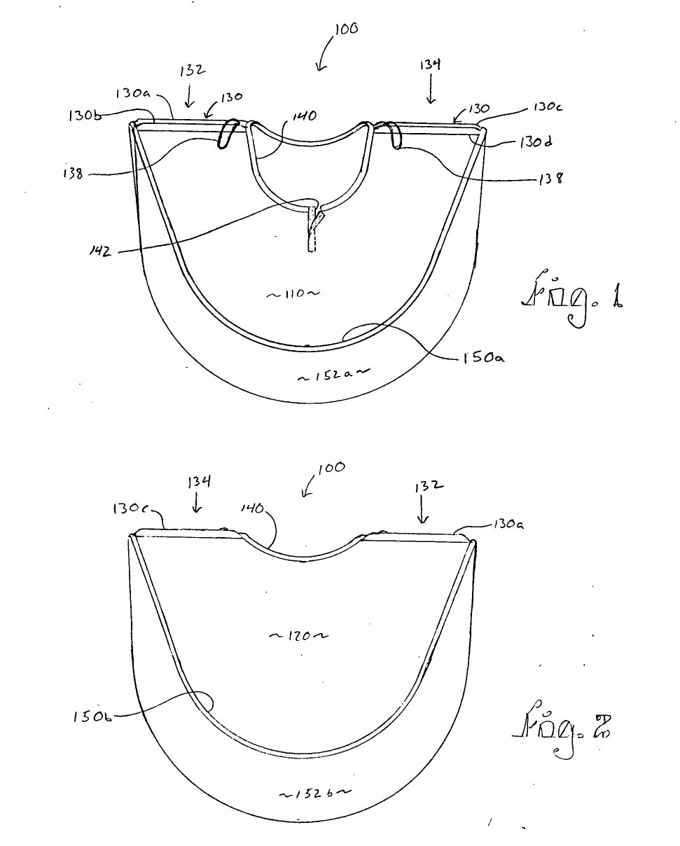

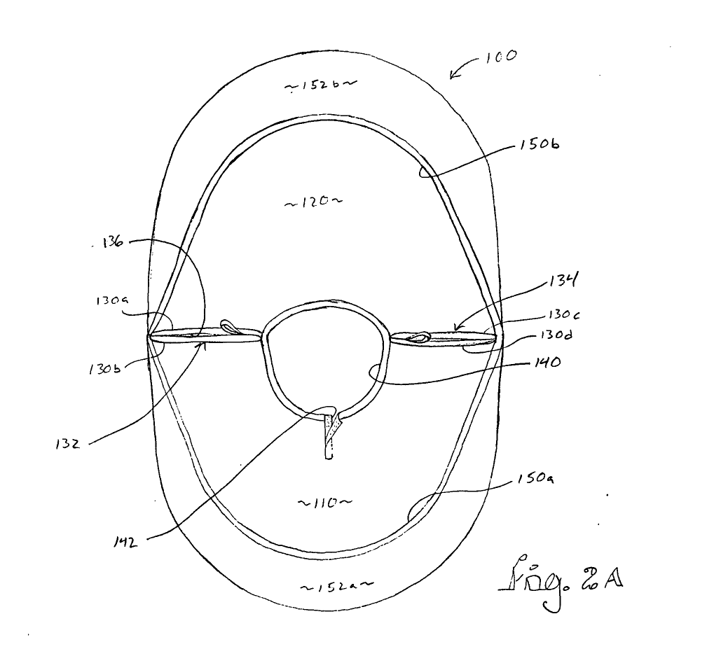

Referring more particularly to the drawings, FIGS. 1 through 2A illustrate front and back views, respectively, of an animal care garment 100 in accordance with the present invention. The garment 100 is provided to protect the clothing of the wearer while handling a pet such as a bird, reptile or small mammal. In addition, the garment has pads 130 located at the shoulder apexes 132, 134 of the garment 100 to provide perches for the pet to rest on during handling. The garment 100 may also provide means such as a lip or pocket for collecting waste or food that drops from the animal during handling.

The garment 100 illustrated in FIGS. 1 through 2A includes a front panel 110 joined at shoulder apexes 132 and 134 to a back panel 120. The panels 110 and 120 may be formed from fabric or other soft, flexible, washable material. The panels 100 and 120 may comprise separate pieces attached to one another at the shoulder apexes 132, 134 or may be formed from opposing portions of a single piece of material. In either case, an opening 140 is provided near the top, center portion of the garment, between the shoulder apexes 132, 134, for receiving the head and neck of a wearer. The opening may include a collar vent 142 for selectively increasing the size of the opening 140. The collar vent 142 may be provided with a means for closure such as buttons or hook and loop fasteners such as Velcro. The general structure associated with the garment illustrated in FIGS. 1 through 2A is often described as a cape.

As shown in FIGS. 1 through 3, a pair of elongated, generally cylindrical, flexible, washable pads 130 are secured in parallel along the shoulder line to the top surfaces of the shoulder apexes 132, 134. These pads 130 are preferably formed of cloth-covered synthetic rope. Rope formed of synthetic materials such as nylon is preferred because it tends not to retain water and therefore allows the pad to dry quickly after washing. Alternatively, a pad may comprise foamed polymeric material, such as materials of the type commonly referred to as foam rubber.

The pad is sized to a cross-sectional width optimized to serve as a perch. For example, the diameter of the rope used in constructing a pad may be selected according to the size of perch required by the animal to be handled. Rope having a diameter of 1/4 inch to 1 inch is generally suitable.

The pads 130 are preferably formed by sewing selected material to form a tube completely surrounding a section of rope. A first pad 130a is then sewn along the shoulder line of one of the shoulder apexes 132. A second pad 130b is sewn along the shoulder line, next to the first pad 130a, to form a parallel arrangement. Typically, the ends of the pads 130 are sewn to the top surfaces at the shoulder apexes 132, 134 and then covered by edging or piping 112.

The side-by-side, parallel arrangement of the pads 130 provide a particularly suitable perch for a pet such as parrot. By providing two pads 130, the surface area on which the animal may rest or move about is increased. In addition, the animal may grip one or both pads 130 when resting and moving about, providing increased variety of leg movement and placement. Since the pads 130 are in close proximity, a garment having pads 130 of relatively small diameter may still provide a suitable perch for larger animals since the animal, for example a parrot, may grip both pads 130 simultaneously with one foot.

Preferably, each pad 130 is sewn along its length to the underlying surface of the garment 100 so that a walled channel 136 is formed between the pads 130. This channel 136 may serve as a receptacle for food materials or as a resting place for small animals. In addition, the channel 136 may include a means for attaching an object such as a toy item to the garment. As illustrated in the figures, particularly FIGS. 2A and 3, the attachment means may comprise a loop 138 of material or cord extending from the channel 136. As illustrated in FIGS. 2A and 3, the loop 138 may be secured to the garment 100 in proximity to the piping 112 provided around the edge of the neck opening 140. The loop 138 may be stored within the channel when not in use, or withdrawn to attach an object to the garment.

In addition to the above features, an animal care garment 100 may include means for collecting food and animal waste during handling. The garment 100 illustrated in FIGS. 1 through 2A provides such means through a lip 150 extending around the sides and lower perimeter of each panel 110, 120. The lip 150 includes an outer wall 152 spaced away from the outer, lower surface of the panel 110, 120 thereby forming an open-topped receptacle for receiving waste, food or other debris from the shoulder apexes 132, 134. As illustrated in FIGS. 1 through 2A, the lip 150 preferably extends along the sides of the panel 110, 120 as well as the lower perimeter so that debris projected from the shoulder areas at angle may still be captured and retained rather than falling to the ground or on to the clothing of the wearer. In addition, the lip 150 may serve as a means for storing materials used during the handling of animals or for carrying small animals.

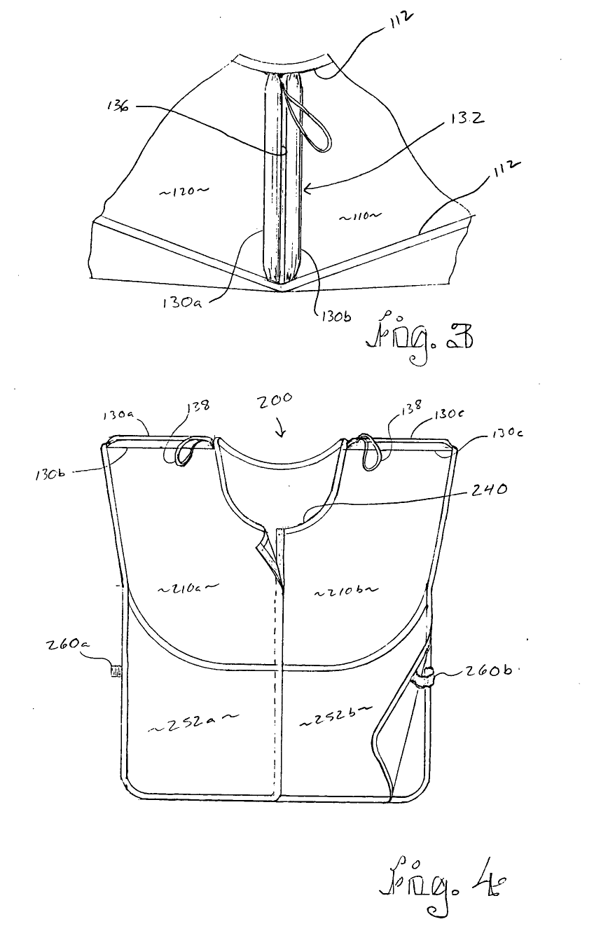

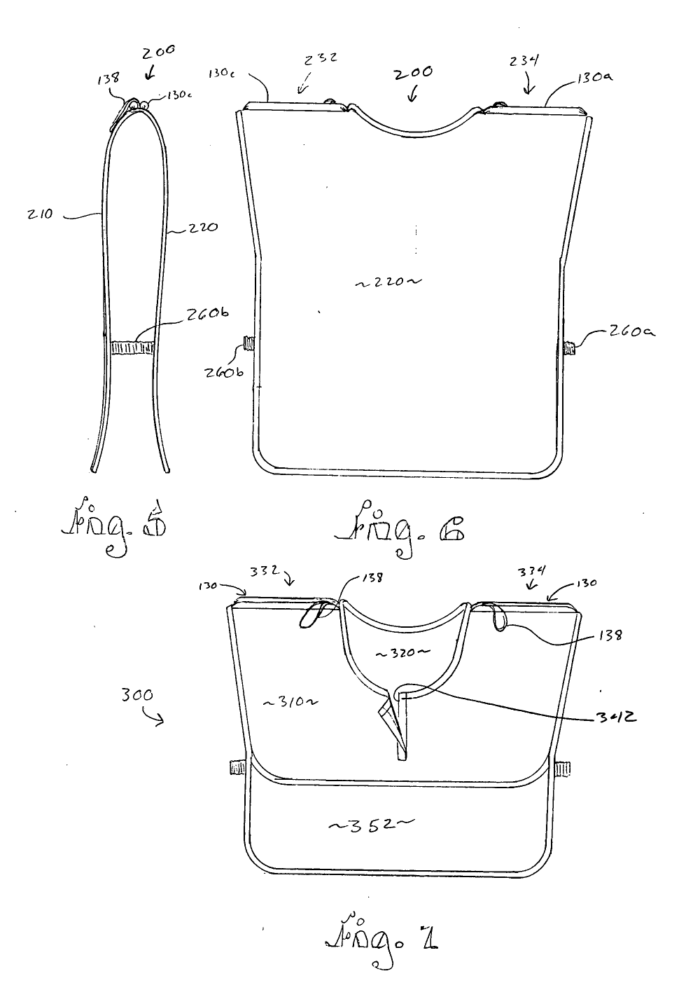

FIGS. 4 through 7 illustrate alternative embodiments of an animal care garment (200, 300). FIGS. 4 through 6 illustrate an animal care garment 200 wherein the front panel 210 has been divided into left and right subpanels 210a and 210b, thereby providing an overall structure commonly known as a vest. As illustrated, the vest-shaped garment 200 includes pads 130 and loops 138 substantially similar in structure and function to those described above. Rather than a lip, however, the garment 200 may be provided with pockets 252a, 252b for receiving debris or carrying materials or animals. Preferably, the pockets 252a, 252b each include an outer wall that extends at least halfway up the side of the garment 200 to facilitate capture of debris emanating from the shoulder apexes 232, 234. As shown in FIGS. 4 through 6, and particularly in FIG. 5, the garment 200 may include means for holding the front and back panels 210, 220 close to one another and against the body of the wearer. Such means may include a band or strap 260. FIGS. 4 through 6 illustrate elastic bands 260a, 260b, each attached at one end to a side portion of a front panel 210a or 210b and at the other end to a side portion of the back panel 220.

FIG. 7 illustrates another embodiment of an animal care garment 300 having features similar to both previously described embodiments 100 and 200. The front panel 310 is joined to a back panel 320 at the shoulder apexes 332, 334, and pads 130 and loops 138 are provided as previously described. As illustrated, the front panel 310 is not divided but includes a collar vent 342. An elongated pocket or pouch 352 is provided along the lower portion of the front panel for receiving debris. This embodiment may provide more protection than the first embodiment 100 but allow greater freedom of movement than the second embodiment 200.

The foregoing is illustrative of the principles of the present invention. It will be appreciated that various modifications, additions and improvements may readily occur to those skilled in the art and may be incorporated without departing from the scope of the invention as claimed.

1. (cancelled)

2. (cancelled)

3. (cancelled)

4. An animal care garment comprising:
a front panel communicating with a back panel at a pair of spaced shoulder apexes to present a neck opening therebetween,
said panels having a first top surface covering one of said shoulder apexes and a second top surface covering the other of said shoulder apexes,
a pair of elongated, generally cylindrical, flexible, washable pads, said pads sized to a cross-sectional width optimized to serve as a perch for a small animal, said pads secured in parallel along the shoulder line to at least one of said top surfaces to form a channel between said pads,
means for attaching an object to said garment, said attachment means extending from said channel, and
an outer wall spaced away from the outer, lower surface of at least one of said panels, said wall to define an open-topped receptacle for receiving debris falling from said shoulder apex.

5. The animal care garment of claim 4 wherein said pad comprises fabric-covered rope.

6. The animal care garment of claim 4 wherein said pad comprises foamed polymeric material.

7. An animal care garment comprising:
a panel having a longitudinal axis, a transverse axis, an outer edge and an inner edge, said outer edge defining the perimeter of said panel and said inner edge defining an aperture sized to accept the neck of a wearer, said aperture disposed near the intersection of said axes,
at least one pair of parallel, flexible pads attached to a portion of a top surface of said panel located along said transverse axis and between said inner and outer edges, and
a walled channel formed between said pads.

8. The animal care garment of claim 7 wherein said pads each comprise a section of rope.

9. The animal care garment of claim 8 wherein said rope is formed of synthetic water resistant material.

10. The animal care garment of claim 7 wherein said pad comprises foamed polymeric material.

11. The animal care garment of claim 7 wherein said pads are sized to a cross-sectional width optimized to serve as a perch.

12. The animal care garment of claim 7 wherein each of said pads has a first end and a second end, said first end secured to said panel in proximity to said inner edge, said second end secured to said panel in proximity to said outer edge, whereby each of said pads lies substantially along said transverse axis.

13. The animal care garment of claim 7 further comprising a means for securing an object in proximity to said pads.

14. The animal care garment of claim 7 further comprising a loop secured between said pads.

15. The animal care garment of claim 7 further comprising means for receiving food and waste.

16. The animal care garment of claim 7 further comprising means for carrying small animals.

17. The animal care garment of claim 7 further comprising a lip extending from a portion of said outer edge so that when said garment is placed upon the shoulders of a wearer, said lip forms a receptacle for receiving food, waste or other matter traversing along an outer surface of said panel.

18. An animal care garment comprising:
a front panel communicating with a back panel at a pair of spaced shoulder apexes to present a neck opening therebetween,
said panels having a first top surface covering one of said shoulder apexes and a second top surface covering the other of said shoulder apexes,
a pair of elongated, generally cylindrical, flexible, washable pads secured in parallel along the shoulder line to at least one of said top surfaces, and
means for receiving and retaining debris falling from said shoulder apexes.

19. The animal care garment of claim 18 further comprising means for attaching an object to said garment, said attachment means extending from one of said top surfaces.

20. The animal care garment of claim 18 wherein each of said panels includes a lower perimeter and transverse sides and wherein said means for receiving and retaining comprises a lip extending around said sides and lower perimeter of at least one of said panels.

21. The animal care garment of claim 18 wherein said means for receiving and retaining comprises a pocket including an outer wall extending upward from a lower perimeter of said front panel and part way along a side of said front panel, whereby debris projected from said shoulder apex may be captured and retained within said pocket.
